(19) United States
(12) Patent Application Publication
(10) Pub. No.: US 2003/0090704 A1
(43) Pub. Date: May 15, 2003

(54) System and method for configuring a printing device

(76) Inventor: Von L. Hansen, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/999,422

(22) Filed: Nov. 15, 2001

(51) Int. Cl. G06F 3/12; G06F 9/00

(52) U.S. Cl. 358/1.15; 710/17; 709/327

(57) ABSTRACT

The present disclosure relates to a system and method for configuring a printing device. In one arrangement, the system and method pertain to determining that the printing device is accessible, and downloading a configuration applet to the printing device, the configuration applet being configured to execute on a virtual machine of the printing device and automatically configure the printing device for use. In addition, the present disclosure relates to a printing device. In one arrangement, the printing device comprises a processing device, and memory including a virtual machine and a configuration applet that is executed by the virtual machine, the configuration applet including logic configured to facilitate downloading of a printing device driver.

### FIELD OF THE INVENTION

The present disclosure relates to a system and method for configuring a printing device. More particularly, the disclosure relates to a system and method with which the configuration of a new printing device is, at least partially, automated for the user.

### BACKGROUND OF THE INVENTION

When a new printing device is obtained, various software normally must be installed in order to be able to use the device with a host device such as a personal computer (PC). Such software typically comprises a device driver and various applications. For example, printer drivers are typically needed to send jobs from an application (e.g., word processing application) operating on a PC to a printing device.

Such software is usually provided to the user upon purchase of the printing device. Alternatively or in addition, software updates may be made available for downloading from the Internet. In that the software is specifically adapted for accessing and using a particular printing device, different software normally must be installed for each device that the user intends to access. Moreover, to obtain optimal performance, the user may need to periodically update the software as improved versions are developed by the device manufacturer.

Understandably, the requirement of having to repeatedly install new and/or improved software can be cumbersome to the user. This is particularly true in the case of medium to large networks in which new devices are often added to the network. In addition, where the user is not computer savvy, having to install such software can be discouraging to the user. From the device manufacturer's perspective, the provision of such software to the user for installation is likewise undesirable in terms of software distribution and customer support.

From the foregoing, it can be appreciated that it would be desirable to have a system and method for configuring a printing device that, at least partially, automates the configuration process for the user.

### SUMMARY OF THE INVENTION

The present disclosure relates to a system and method for configuring a printing device. In one arrangement, the method comprises the steps of determining that the printing device is accessible, and downloading a configuration applet to the printing device, the configuration applet being configured to execute on a virtual machine of the printing device and automatically configure the printing device for use.

In one arrangement, the system comprises means for determining that the printing device is accessible, and means for downloading a configuration applet to the printing device, the configuration applet being configured to execute on a virtual machine of the printing device and automatically configure the printing device for use.

In addition, the present disclosure relates to a printing device. In one arrangement, the printing device comprises a processing device, and memory including a virtual machine and a configuration applet that is executed by the virtual machine, the configuration applet including logic configured to facilitate downloading of a printing device driver.

Other systems, methods, features, and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view of an example system.

FIG. 2 is a schematic view of a printing device shown in FIG. 1.

FIG. 3 is a schematic view of a computing device shown in FIG. 1.

FIG. 4 is a flow diagram that illustrates an example of the operation of a printing device configuration module of the computing device shown in FIG. 3.

FIG. 5 is a flow diagram that illustrates an example of the operation of an automatic configuration module of the printing device shown in FIG. 2.

FIG. 6 is a flow diagram that illustrates an example of the operation of a configuration applet that can be downloaded to the printing device shown in FIG. 2.

### DETAILED DESCRIPTION

Disclosed is a system and method for configuring a printing device. To facilitate description of the system and method, an example system will first be discussed with reference to the figures. Although this system is described in detail, it will be appreciated that this system is provided for purposes of illustration only and that various modifications are feasible without departing from the inventive concept. After the example system has been described, examples of operation of the system will be provided to explain the manners in which printing devices can be configured with the system and method.

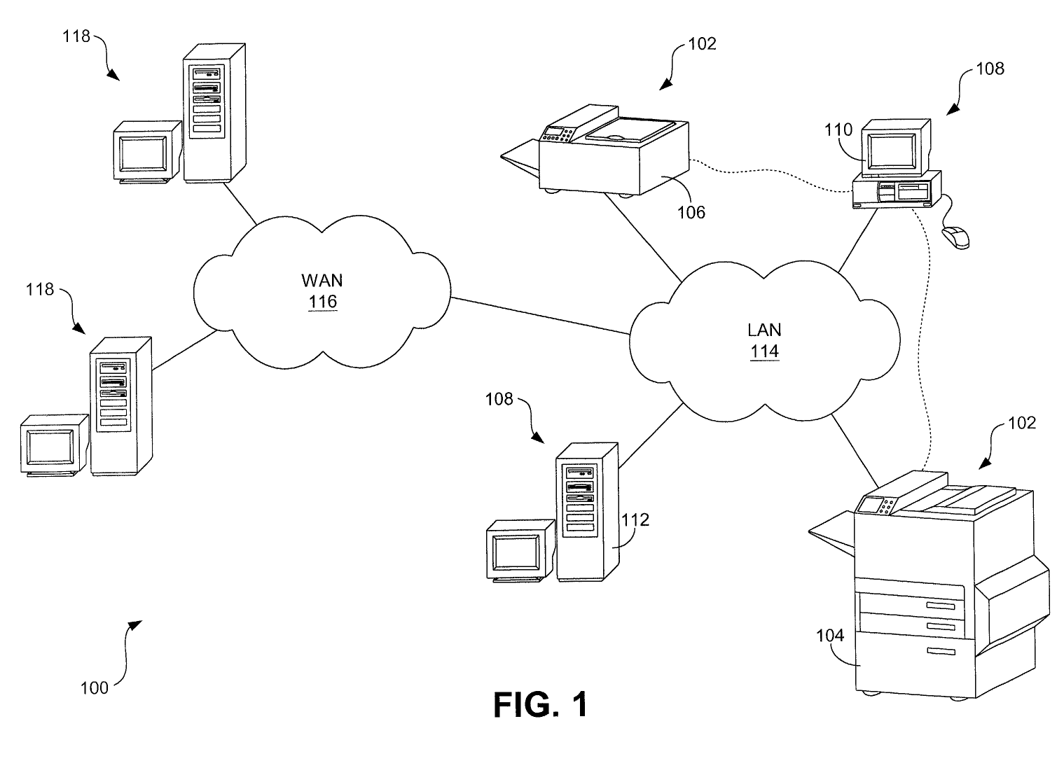

Referring now in more detail to the drawings, in which like numerals indicate corresponding parts throughout the several views, FIG. 1 illustrates an example system 100. As indicated in this figure, the system 100 generally comprises one or more printing devices 102. By way of example, these printing devices can comprise a printer 104 and a multifunction peripheral (MFP) 106. Although these particular printing devices are shown in FIG. 1 and are explicitly identified herein, it is to be understood that the printing devices 102 can comprise substantially any device that is capable of generating hard copy documents including photocopiers, facsimile machines, etc.

In addition to the printing devices 102, the system 100 can include one or more computing devices 108. The computing devices 108 comprise substantially any device that is capable of use with the printing devices 102 and, more particularly, which is capable of communicating with the printing device by transmitting data to and/or receiving data from the printing device. By way of example, the computing devices 104 comprise a personal computer (PC) 110 and a network server 112. Although these particular types of computing devices are identified in FIG. 1 and discussed herein, it will be appreciated that any one of the computing devices 108 could, alternatively, comprise another type of computing device including, for instance, a notebook computer, a personal digital assistant (PDA), a mobile telephone, etc.

As is further identified in FIG. 1, the printing devices 102 and the computing devices 108 can, optionally, be connected to a network 114. By way of example, the network 114 comprises a local area network (LAN) that is used in an office or home setting. As is also indicated in FIG. 1, the PC 110 can be directly connected to one or more of the printing devices 102, if desired.

The network 114 is preferably connected to a further network 116 which typically is arranged as a wide area network (WAN) that includes one or more sub-networks. Indeed, in some embodiments, the network 116 may comprise a set of networks that forms part of the Internet. As indicated in FIG. 1, one or more further computing devices 118, typically web servers, can be connected to the network 116.

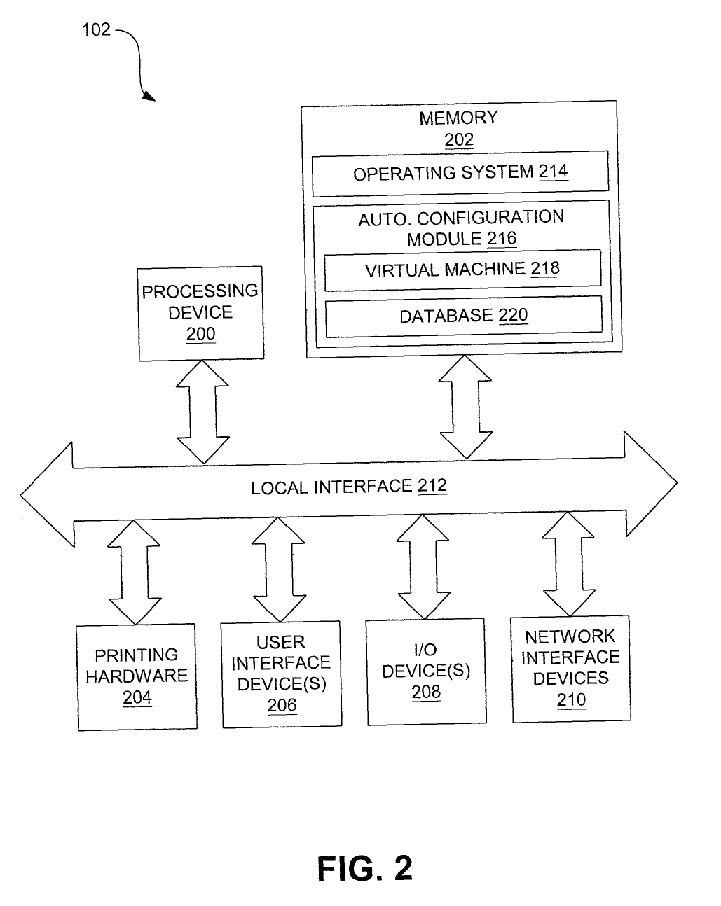

FIG. 2 is a schematic view illustrating an example architecture for the printing devices 102 shown in FIG. 1. As indicated in FIG. 2, each printing device 102 can comprise a processing device 200, memory 202, printing hardware 204, one or more user interface devices 206, one or more input/output (I/O) devices 208, and one or more network interface devices 210. Each of these components is connected to a local interface 212 that, by way of example, comprises one or more internal buses. The processing device 200 is adapted to execute commands stored in memory 202 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the printing device 102.

The printing hardware 204 comprises the components with which the printing device 102 can generate hard copy documents. For example, the printing hardware 204 can comprise a print engine that is possible of many different configurations. The one or more user interface devices 206 typically comprise interface tools with which the device settings can be changed and through which the user can communicate commands to the printing device 102. By way of example, the user interface devices 206 comprise one or more function keys and/or buttons with which the operation of the printing device 102 can be controlled, and a display, such as a liquid crystal display (LCD), with which information can be visually communicated to the user and, where the display comprises a touch-sensitive screen, commands can be entered.

With further reference to FIG. 2, the one or more I/O devices 208 are adapted to facilitate connection of the printing device 102 to another device, such as a computing device 108, and may therefore include one or more serial, parallel, small computer system interface (SCSI), universal serial bus (USB), IEEE 1394 (e.g., Firewire™), and/or personal area network (PAN) components. The one or more network interface devices 210 comprise the various components used to transmit and/or receive data over the network 114 (and network 116, where applicable). By way of example, the network interface devices 210 include a device that can communicate both inputs and outputs, for instance, a modulator/demodulator (e.g., modem), wireless (e.g., radio frequency (RF)) transceiver, a telephonic interface, a bridge, a router, network card, etc.

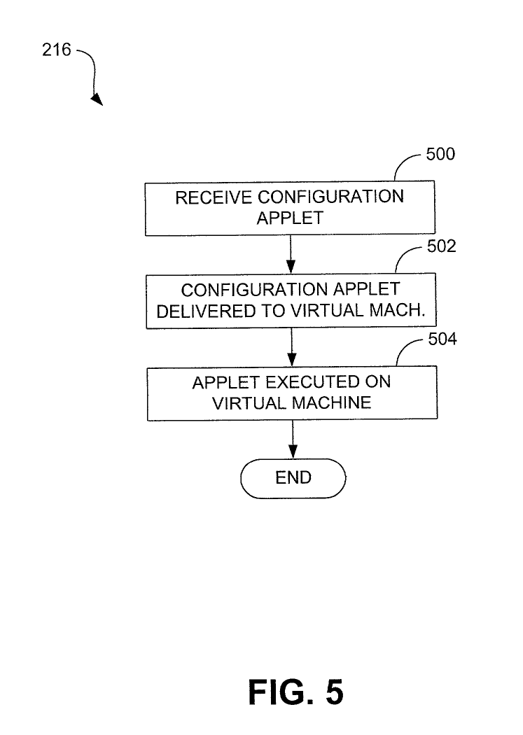

The memory 202 includes various software and/or firmware programs including an operating system 214, an automatic configuration module 216, and a virtual machine 218. The operating system 214 contains the various commands used to control the general operation of the printing device 102 while the automatic configuration module 216 comprises the various commands to control configuration of the printing device 102. Operation of the automatic configuration module 216 is described below with reference to FIG. 5. The virtual machine 218 comprises software and/or firmware that is configured to execute one or more configuration applets that are downloaded to the printing device 102. Where the applets comprise Java applets, the virtual machine 218 can comprise Java Virtual Machine (JVM). As is discussed below, the virtual machine 218 can be used to facilitate configuration of the printing device 102. In addition to these programs, the memory 202 can also include a database 220 that is used to store various information relevant to printing device configuration such as, for instance, settings preferences, fonts, document forms, etc.

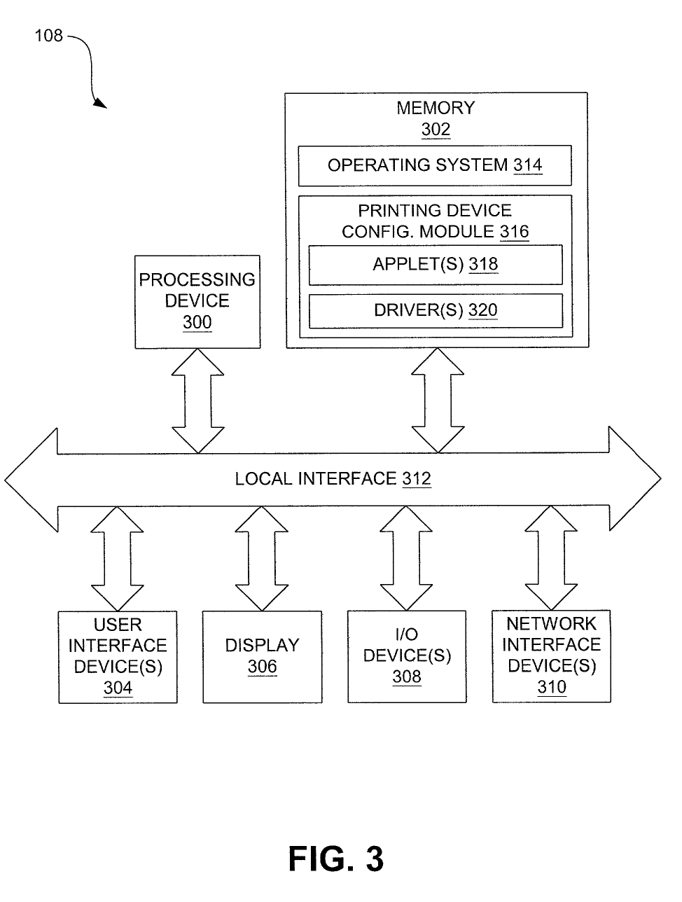

FIG. 3 is a schematic view illustrating an example architecture for the computing devices 108 shown in FIG. 1. As indicated in FIG. 3, each computing device 108 can comprise a processing device 300, memory 302, one or more user interface devices 304, a display 306, one or more I/O devices 308, and one or more networking devices 310, each of which are connected to a local interface 312. The processing device 300 can include any custom made or commercially available processor, a central processing unit (CPU) or an auxiliary processor among several processors associated with the computing device 108, a semiconductor based microprocessor (in the form of a microchip), or a macroprocessor. The memory 302 can include any one of a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 304 comprise those components with which the user can interact with the computing device 108. For example, where the computing device 108 comprises a PC, these components can comprise a keyboard and mouse. Where the computing device 108 comprises a handheld device (e.g., PDA, mobile telephone), these components can comprise function keys or buttons, a touch-sensitive screen, etc. The display 306 can comprise a computer monitor or plasma screen for a PC or an LCD for a handheld device. The one or more I/O devices 308 and the one or more network interface devices 310 operate and can have similar configuration to the like-named components described above with relation to FIG. 2.

The memory 302 normally comprises an operating system 314 and a printing device configuration module 316. The operating system 314 controls the execution of other software and provides scheduling, input-output control, file and data management, memory management, and communication control and related services. The printing device configuration module 316 comprises software that is used to facilitate the automatic configuration of the printing devices 102. The module 316 can comprise, for instance, one or more configuration applets 318 that, as is discussed below, can be downloaded to the printing devices 102, and one or more drivers 320 that can be downloaded to the printing devices.

Various software and/or firmware programs have been described herein. It is to be understood that these programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

An example system 100 having been described above, operation of the system will now be described. In the discussions that follow, flow diagrams are provided. It is to be understood that any process steps or blocks in these flow diagrams represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

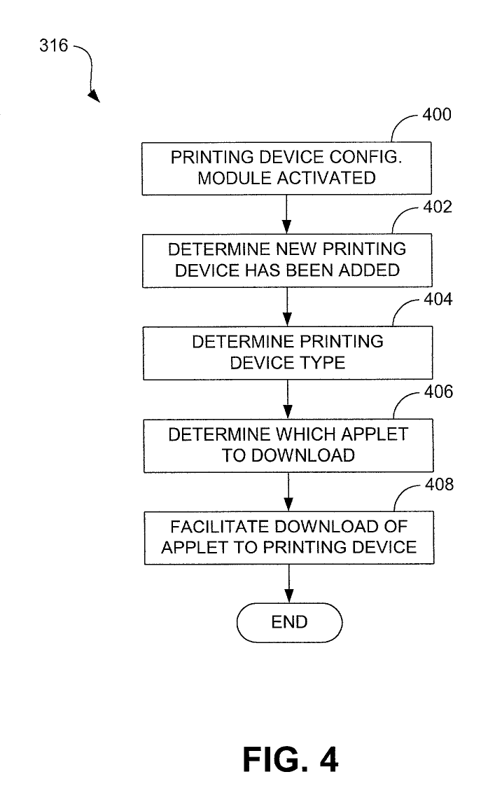

Beginning with FIG. 4, illustrated is an example of facilitation of automatic configuration of the printing device 102. More specifically, shown is an example of the manner in which the configuration process can be initiated by the printing device configuration module 316 of a computing device 108. As indicated in block 400, the printing device configuration module 316 is first activated. This activation can occur in various different ways. By way of example, the module 316 can be manually activated by a user (e.g., system administrator) by identifying the presence of a newly added printing device 102 to the module. This identification can be made by accessing an appropriate application associated with the printing device configuration module 316. For instance, the user can provide the address of the new printing device 102 to the module 316 by entry of this information with the application.

In another example, the presence of the new printing device 102 can be automatically detected by the printing device configuration module 316. In such a case, the module 316 can be adapted to send out periodic response requests (i.e., pings) on the network 114 to every device that is connected thereto. Once a request is received by each device connected to the network 114, including the new printing device 102, the configuration module 316 can determine what devices are connected to the network, as well as the addresses of these various devices, from their response communications. In an alternative arrangement, the newly added printing device 102 can be configured to send out periodic notifications that identify its presence to other devices on the network 114, including the computing device 108.

In any case, once the printing device configuration module 316 is activated, the device can determine that a new printing device 102 has been added to the network 114, as indicated in block 402. At this point, the configuration module 316 can determine what type of device the printing device 102 is, as indicated in block 404. In terms of type, the module 316 can, for instance, determine whether the device is a printing device, the manufacturer of the printing device, the device model number, etc. By way of example, this information can, optionally, be obtained from the response communication or the notification communication received from the printing device 102. Alternatively, the information can be obtained by querying the printing device 102 and receiving an appropriate response.

With this information, the printing device configuration module 316 can determine what configuration applet 318 is to be downloaded to the printing device 102, as indicated in block 406. Notably, this configuration applet 318 may be the same for each printing device 102 added to the network 114 regardless of the printing device's type in that the applet normally is device independent, i.e., independent of the configuration and operating language used by the printing device. However, the type of applet 318 downloaded to the printing device 102 may be device dependent where the nature of the configuration of the device depends upon the device's architecture (e.g., whether the device is web-enabled, whether the device has a mass memory device, etc.).

The printing device configuration module 316 can then facilitate downloading of an appropriate configuration applet 318 to the printing device 102, as indicated in block 408. Where the configuration applet 318 is stored on the computing device 108, this facilitation merely comprises downloading the applet to the printing device 102. Where, however, the appropriate configuration applet 318 is not stored on the computing device 108, facilitation may comprise transmitting a request to a remote device, e.g., a computing device 118, to download the correct configuration applet to the printing device 102. At this point, participation of the printing device configuration module 318 in the configuration process is terminated.

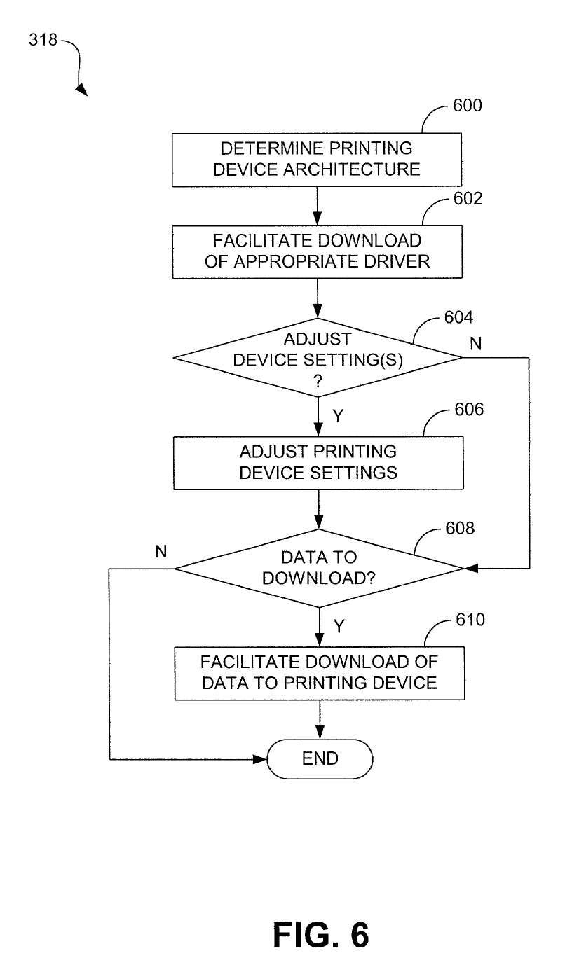

FIG. 5 illustrates an example of operation of the automatic configuration module 216 of the printing device 102 as used to facilitate automatic configuration of the printing device for use. Beginning with block 500, the automatic configuration module 216 receives a configuration applet 318 from the computing device 108 that, for example, was sent to the printing device 102 in the manner described above with reference to FIG. 4. Notably, however, the applet could be received in alternative ways. For instance, the applet 318 could be downloaded to the printing device 102 from a remote location, e.g., computing device 118, where the printing device is configured to automatically access the remote location upon first being connected to the network 114. In any case, once the applet 318 is received by the automatic configuration module 216, it is delivered to the virtual machine 218, as indicated in block 502, and the applet is executed by the virtual machine 218 to configure the device, as indicated in block 504. An example of this execution is described below with regard to FIG. 6.

FIG. 6 illustrates an example of operation of the configuration applet 318 during its execution by the virtual machine 218. Accordingly, depicted is execution of the applet 318 with the virtual machine 218 in an automatic configuration operation. Beginning with block 600, the applet 318 can determine the printing device 102 architecture. In particular, the applet 318 can determine the operating characteristics of the printing device 102, whether the device has a mass memory storage device (e.g., hard disk, CDROM), the enabled functionalities of the device (e.g., stapling, folding, color printing, etc.), and any other information regarding the device that might be pertinent to its configuration. Notably, this step may be unnecessary where the initial communications between the computing device 108 and the printing device 102 uncovered this information.

At this point, the configuration applet 318 can facilitate downloading of an appropriate driver, if necessary, that will be needed to access and use the printing device 102, as indicated in block 602. Notably, where the computing device 108 already has an appropriate driver, download, may not be necessary. Assuming it does not, however, the applet 318 can retrieve the driver from a remote location, e.g., computing device 118, via the network interface devices 208, so that the driver can be downloaded. In one arrangement, the driver can be downloaded directly to the printing device. This may be desirable where the printing device 102 has a mass memory storage device (e.g., hard disk). Alternatively, where the printing device has limited memory space, the applet 318 can transmit a request to the remote location and identify the address of each computing device 108 that is connected to the network 114 that is to be provided with a copy of the driver. In some scenarios, the applet may be configured to only provide the address of a printer server (e.g., server 112) that is to have the printing device driver where centralized printing control is desired.

Once the driver or drivers have been downloaded, the configuration applet 318 can determine whether the printing device settings are to be adjusted, as indicated in decision element 604. If not, i.e., the default settings for the printing device 102 established by the manufacturer are to be left unchanged, flow continues down to decision element 608 described below. If, on the other hand, the settings are to be adjusted, flow continues to block 606 at which the applet 318 adjusts these settings. For example, these settings can pertain to the default fonts, paper sizes, contrast settings, scaling, etc.

Referring next to decision element 608, it can be determined whether any other data are to be downloaded to the printing device 102. By way of example, these data can comprise company fonts, forms, etc. that may be desired by the user. In terms of forms, downloaded can be shells that are used frequently in the particular network environment in which the printing device 102 is used. For instance, where the printing device 102 is to be used by tax return preparers, it may be desirable to download IRS Form 1040 shells to the printing device so as to reduce the amount of data that must be transmitted to and processed by the printing device 102. If no such data are to be downloaded to the printing device 102, flow is terminated. If, however, data are to be downloaded, the configuration applet 318 can facilitate the download of these data, as indicated in block 610. Again, this facilitation can comprise transmitting a download request to a remote device (e.g., computing device 118) that stores these data.

Although a particular mode of operation has been described above for the configuration applet 318, it is to be understood that this mode of operation has been presented as an illustration of one manner in which the applet downloaded to the printing device 102 can function. It will be appreciated that the applet 318 can be configured to operate in alternative manners which depend upon the type of printing device configuration that is desired. Accordingly, the discussion presented with reference to FIG. 6 is not intended to limit the scope of the present disclosure.

While particular embodiments of the invention have been disclosed in detail in the foregoing description and drawings for purposes of example, it will be understood by those skilled in the art that variations and modifications thereof can be made without departing from the scope of the invention as set forth in the following claims. Although the operation of the configuration applet 318 was described only in the initial configuration context, persons having ordinary skill in the art will appreciate that the applet can be used in others. For instance, the applet 318 can be configured to periodically retrieve updated drivers or other data to be used to access and control operation of the printing device 102.

What is claimed is:

1. A method for facilitating configuration of a printing device, comprising the steps of:
determining that the printing device is accessible; and
downloading a configuration applet to the printing device, the configuration applet being configured to execute on a virtual machine of the printing device and automatically configure the printing device for use.

2. The method of claim 1, wherein the step of determining that the printing device is accessible comprises determining that the printing device is connected to a network.

3. The method of claim 1, wherein the step of downloading a configuration applet comprises downloading a configuration applet that is configured to facilitate download of a driver for the printing device.

4. The method of claim 3, wherein the step of downloading a configuration applet comprises downloading a configuration applet that is configured to facilitate download of a driver directly to the printing device.

5. The method of claim 3, wherein the step of downloading a configuration applet comprises downloading a configuration applet that is configured to facilitate download of a driver to a computing device that accesses the printing device.

6. The method of claim 1, wherein the step of downloading a configuration applet comprises downloading a configuration applet that is configured to adjust at least one setting of the printing device.

7. The method of claim 1, wherein the step of downloading a configuration applet comprises downloading a configuration applet that is configured to facilitate downloading of data to the printing device.

8. The method of claim 7, wherein the data to be downloaded to the printing device comprises font data.

9. The method of claim 7, wherein the data to be downloaded to the printing device comprises forms data.

10. A system for facilitating configuration of a printing device, comprising:
means for determining that the printing device is accessible; and
means for downloading a configuration applet to the printing device, the configuration applet being configured to execute on a virtual machine of the printing device and automatically configure the printing device for use.

11. The system of claim 10, wherein the means for determining that the printing device is accessible comprises means for determining that the printing device is connected to a network.

12. The system of claim 10, wherein the means for downloading a configuration applet comprises means for downloading a configuration applet that is configured to facilitate download of a driver for the printing device.

13. The system of claim 10, wherein the means for downloading a configuration applet comprises means for downloading a configuration applet that is configured to adjust at least one setting of the printing device.

14. The system of claim 10, wherein the means for downloading a configuration applet comprises means for downloading a configuration applet that is configured to facilitate downloading of data to the printing device.

15. A configuration applet for execution by a virtual machine stored on a printing device, comprising:
logic configured to facilitate downloading of a printing device driver; and
logic configured to adjust at least one setting of the printing device.

16. The configuration applet of claim 15, further comprising logic configured to facilitate download of data to the printing device.

17. The configuration applet of claim 16, wherein the logic configured to facilitate download of data comprises logic configured to facilitate download of font data.

18. The configuration applet of claim 16, wherein the logic configured to facilitate download of data comprises logic configured to facilitate download of forms data.

19. The configuration applet of claim 15, further comprising logic configured to determine the architecture of the printing device.

20. A printing device, comprising:
a processing device; and
memory including a virtual machine and a configuration applet that is executed by the virtual machine, the configuration applet including logic configured to facilitate downloading of a printing device driver.

21. The printing device of claim 20, wherein the configuration applet further comprises logic configured to adjust at least one setting of the printing device.

22. The printing device of claim 20, wherein the configuration applet further comprises logic configured to facilitate download of data to the printing device.

23. The printing device of claim 20, wherein the configuration applet further comprises logic configured to determine the architecture of the printing device.
